(19) United States
(12) Patent Application Publication
(10) Pub. No.: US 2006/0222854 A1
(43) Pub. Date: Oct. 5, 2006

(54) High density carbon foam

(76) Inventors: Thomas M. Matviya, McKees Rocks, PA (US); Rick Lucas, St. Clairsville, OH (US)

Correspondence Address: PHILIP D. LANE, P.O. BOX 79318, CHARLOTTE, NC, 28271-7063, US

(21) Appl. No.: 11/393,308

(22) Filed: Mar. 30, 2006

Related U.S. Application Data
(60) Provisional application No. 60/594,355, filed on Mar. 31, 2005.

(51) Int. Cl. B32B 9/00

(52) U.S. Cl. 428/408

(57) ABSTRACT

High density carbon foams and methods for producing the same are described. A method used to prepare high density carbon foam may involve heating a comminuted agglomerating bituminous coal to an elevated temperature sufficient to result in the coal particles softening and melting together to form a generally homogeneous, continuous, open cell carbon material. The homogeneous open cell carbon material is then maintained at an elevated temperature for a period of time sufficient to substantially reduce or essentially eliminate the plastic property of the bituminous coal. As desired, the resultant high density carbon foam may be cooled to essentially ambient temperatures or immediately or subsequently heated to elevated temperatures as great as about 3200° C., followed by cooling.

### CROSS-REFERENCE TO RELATED APPLICATIONS

This application claims priority to U.S. Provisional Patent Application No. 60/594,355 filed Mar. 31, 2005, which is herein specifically incorporated by reference in its entirety.

### STATEMENT OF FEDERALLY SPONSORED RESEARCH OR DEVELOPMENT

This invention was made with Government support under contract number W9113M-04-C-0109 awarded by the Army Space and Missile Defense Command. The Government has certain rights in the invention.

### FIELD OF THE INVENTION

The present invention is directed to high density porous carbon materials, and in particular, to high density carbon foam.

### BRIEF SUMMARY OF THE INVENTION

The present invention includes high density carbon foam materials and methods for producing the same. In some embodiments, the method used to prepare high density carbon foam involves heating comminuted agglomerating bituminous coal to an elevated temperature sufficient to result in the coal particles softening and melting together to form a generally homogeneous, continuous, open cell carbon material. The homogeneous open cell carbon material is then maintained at an elevated temperature for a period of time sufficient to substantially reduce or essentially eliminate the plastic properties of the bituminous coal to result in high density carbon foam. As desired, the resultant high density carbon foam may be cooled to essentially ambient temperatures or immediately or subsequently heated to elevated temperatures as great as about 3200° C., followed by cooling.

In certain embodiments, the invention may include a method for producing a high density carbon foam, comprising the steps of heating a solid, particulate, agglomerating carbonaceous feedstock to a first elevated temperature, where the first elevated temperature is sufficient to cause the agglomerating carbonaceous feedstock particles to become softened, at least partially melt, and intermix to form a substantially homogeneous, non-sintered, open cell carbon material, and continued heating of the carbon material at an elevated temperature for a time sufficient that the carbon material is no longer plastic or capable of becoming plastic to result in high density carbon foam. As desired, the resultant high density carbon foam may be cooled to essentially ambient temperatures or immediately or subsequently heated to elevated temperatures as great as about 3200° C., followed by cooling.

In some embodiments, the invention may also include a method for producing a high density carbon foam, the method comprising the steps of loading a container with comminuted coal to form a coal bed, where the comminuted coal is an agglomerating bituminous coal, covering a bottom surface of the container with a bottom surface covering, where the bottom surface covering is positioned between the coal bed and the bottom surface of the container. The method may also include covering the coal bed with a coal bed covering, placing a rigid sheet material over the coal bed covering, covering the container with a lid, heating the coal bed to a first elevated temperature, wherein the first elevated temperature is sufficient to cause the coal particles to become softened, at least partially melt, and intermix to form a substantially homogeneous, non-sintered, open cell carbon material, and continued heating of the carbon material at an elevated temperature for a time sufficient that the carbon material is no longer plastic or capable of becoming plastic to result in high density carbon foam. As desired, the resultant high density carbon foam may be cooled to essentially ambient temperatures or immediately or subsequently heated to elevated temperatures as great as about 3200° C., followed by cooling.

Still further, the invention may include high density carbon foam comprising a continuous foam body portion comprising interconnected ligaments defining void spaces, where the non-sintered continuous foam body has a density above about 0.8 g/cc.

Further, the invention may include high density carbon foam comprising a continuous foam body portion comprising interconnected ligaments defining void spaces throughout the body and further comprising above about 1% ash content, where the non-sintered continuous foam body has a density above about 0.8 g/cc.

### BRIEF DESCRIPTION OF THE DRAWINGS

FIG. 1 is a diagrammatic, cross-sectional view of a container loaded with comminuted coal in accordance with an embodiment of the invention.

FIG. 2 is illustrates a temperature profile with respect to time used to heat a coal to produce the high density carbon foam of Example 2.

FIG. 3 is illustrates a temperature profile with respect to time used to heat a coal to produce the high density carbon foam of Example 3.

### DETAILED DESCRIPTION OF EMBODIMENTS OF THE INVENTION

High density carbon foams are those carbon foams, that when heated to temperatures greater than about 700° C., and more typically greater than about 950° C., followed by cooling to essentially ambient temperatures, exhibit densities greater than about 0.8 g/cc and more typically greater than about 1.0 g/cc. In certain embodiments, the densities may range from about 0.8 g/cc to about 2.0 g/cc. In other embodiments, the densities may range from about 1.2 g/cc to about 1.8 g/cc In still other embodiments, the densities may range from about 1.3 g/cc to about 1.6 g/cc. To the unaided eye, such carbons may appear to be non-porous solids. However, microscopic examination may show such high density carbon foams have some degree of porosity. Typically, this porosity is evenly distributed in the foam. The porosity of the high density carbon foams provides void volumes within the foam that are predominately in communication with one another and with the exterior of the foam, thus providing a structure that may be referred to as “open celled” or “porous”. Alternatively, materials having no internal void volumes or only void volumes not in communication with the exterior of the material may be referred to as “closed cell” or “nonporous” materials.

In some embodiments, microscopic examination at a magnification of about 90× shows the carbon foams of the present invention are not simply comprised of sintered powders. That is, the vast majority of the coal particulates from which the foam was prepared are predominantly no longer recognizable as individual particles bonded together only at their areas of mutual contact, as would be the case in a sintered material. In appearance, the microscopic structure of the high density carbon foam may be similar, but not equivalent, to the structures of both low density coal based carbon foams and reticulated vitreous carbons. That is, the high density carbon foam may be comprised of defined, regular, void spaces delimited by thick, somewhat curved, interconnected carbon ligaments, which result in a continuous, open-celled, foam-like dense carbon body. Typically, the void spaces of the high density carbon foam do not have a high population of the wide curving walls usually present in the well-defined spherical voids of a low density coal based carbon foam.

In other embodiments, the structure of the high density carbon foam may appear, under microscopic examination at about 90×, to be comprised of numerous randomly interconnected and intertwined small carbon ligaments of random size and orientation. Such interconnected ligaments are continuous through the high density carbon foam. The surfaces of these ligaments may be curved and relatively smooth, non-uniform, irregular, or even occasionally embedded with what may be the remains of coal particles that did not achieve a high degree of plastic character. In such embodiments, void spaces defined by the ligaments may be of random size and shape with limited, if any, spherical characteristics.

High density carbon foams, when heated to temperatures greater than about 700° C., and more typically greater than about 950° C., followed by cooling to essentially ambient temperatures, may have crush strengths greater than about 5000 lbs/in², in some embodiments greater than about 10,000 lbs/in², and in other embodiments greater than about 20,000 lbs/in². The body of these high density foams may be largely isotropic.

Generally, the method used to prepare high density carbon foam involves heating a comminuted agglomerating bituminous coal to an elevated temperature sufficient to result in the coal particles softening and melting together to form a generally homogeneous, continuous, open cell carbon material. The homogeneous open cell carbon material is then maintained at an elevated temperature for a period of time sufficient to substantially reduce or essentially eliminate the plastic properties of the carbon material to result in high density carbon foam. As desired, the resultant high density carbon foam may be cooled to essentially ambient temperatures or immediately or subsequently heated to elevated temperatures as great as about 3200° C., followed by cooling.

The high density carbon foams may be prepared directly from agglomerating bituminous coals. Suitable bituminous coals are those coals that become plastic (i.e. softened) when heated. Such coals may be those having a Free Swell Index (ASTM Standards D720-67, “Standard Method of Test for Free-Swelling Index of Coal”) of greater than about 1, and in some embodiments greater than about 2. The bituminous coals may be of any bituminous coal rank including Low Volatile, Medium Volatile, High Volatile A, High Volatile B, and High Volatile C bituminous coals. Blends of bituminous coals may be utilized providing the resultant blend is agglomerating and corresponds to the Free Sell Index parameters discussed above.

The agglomerating bituminous coal used to prepare the high density carbon foams of the present invention are first comminuted. In some embodiments, the coal is comminuted to a size such that substantially all, or greater than about 98%, of the coal will pass through an 80 mesh screen (U.S. Standard Sieve Series). Such 80 mesh screens have openings of about 0.18 mm. In other embodiments, the coal is comminuted to a size such that substantially all, or greater than about 98%, of the coal will pass through a 140 mesh screen (U.S. Standard Sieve Series). Such 80 mesh screens have openings of about 0.105 mm. In still other embodiments, suitable coals comminuted to other mesh sizes may also be utilized. In various embodiment, the coal may be comminuted to sizes below about 0.42 mm, in other embodiments below about 0.18 mm, and in yet other embodiment below about 0.105 mm.

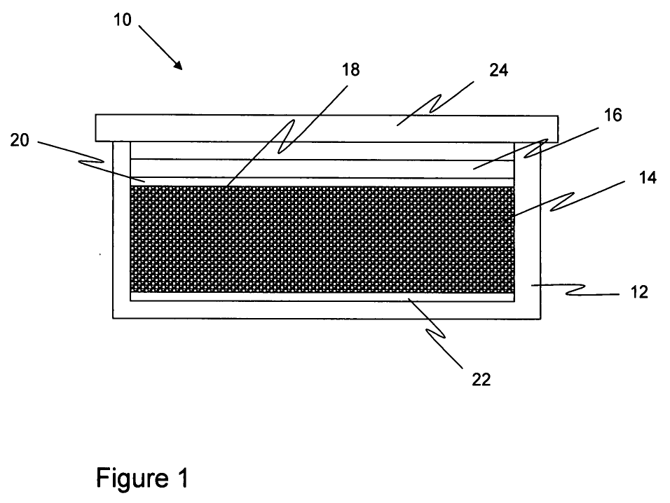

With reference now to FIG. 1, there is shown an embodiment of a high density carbon foam forming apparatus 10 that generally includes a container 12. After sizing, the comminuted coal 14 is placed into a container 12. The container 12 may have any shape or design. In certain embodiments a flat bottom pan is utilized. The container 12 may optionally include a lid 24. The amount of the comminuted coal 14 loaded in the container 12 is not particularly limited. Typically, a sufficient quantity of coal is utilized such that a coal bed is produced wherein the coal particles comprising that coal bed are in mutual contact with neighboring coal particles. In certain embodiments, the mass of coal placed in the container averages about 13 grams per square inch of the container bottom surface area. Other coal loadings may be used to provide the resultant coal bed in the container. The container 12 may be fabricated from any material that is not significantly affected by the selected process conditions of temperature and pressure. Additionally, the container material(s) of construction should not be significantly wet by the plastic coal or significantly degraded by exposure to the coal or coal products at the selected process conditions. Furthermore, container material(s) of construction may be selected with respect to the thermal transport properties and/or dimensional stability of the material(s) of construction over the desired process conditions. Some suitable materials of construction of the container may be, but are not limited to, ceramic materials and metals, including aluminum, stainless steel, and other similar materials.

Generally, the container interior bottom surface may be clean and smooth. Multiple uses of a given container may degrade the bottom interior container surface, due to, for example, the build-up of residues from previous foam production and exposure to the associated process conditions and gases. Such degradation may negatively impact the appearance, smoothness, and/or integrity of the bottom surface of the high density carbon foam product. The container bottom surface may be cleaned by conventional methods such as, but not limited to, washing, the use of abrasives, and the like. Alternatively, a thin metal foil or plate 22 may be placed over the container bottom prior to the introduction of the coal. As with the container bottom, such a metal foil or plate, which may be referred to as a bottom surface covering, 22 may be cleaned as necessary to provide a clean and smooth surface for contact with the coal. Preferably, however, aluminum foil is used as the bottom surface covering metal foil. The use of aluminum foil may provide for a bottom surface covering that is economically disposable after each use, thus eliminating or reducing the need for cleaning of the container or bottom surface covering. Additionally, the use of a bottom surface covering, such as aluminum foil, may provide for easier extraction of the resultant high density carbon foam from the container.

Other materials may be substituted for the metal foils or plates used as bottom surface coverings 22. The metal foils, metal plates, and other materials may be sheet materials having at least one face with a smooth solid surface. These metal foils, metal plates, and other materials, should be capable of tolerating the process temperatures and pressures used in production of the high density carbon foam. Additionally, the bottom surface covering 22 should be essentially non-reactive with the feedstock coal or any products thereof. Furthermore, it is desirous that the bottom surface covering 22 should not be significantly wetted by the feedstock coal when plastic. Preferably, the bottom surface covering 22 should not significantly absorb or adsorb the foaming feedstock coal. It is generally preferred that the bottom surface covering material provide for good heat transport between the container bottom and the feedstock coal and resultant high density carbon foam. Suitable bottom covering materials 22 may include metal foils and sheets, non-porous or glazed ceramic plates, papers, or sheets, and the like. Bottom surface coverings may be perforated with one or more holes, typically of small diameter. Other embodiments may include graphite, or carbon, foils or sheets that satisfy the above discussed criteria as the bottom surface covering. It is generally preferable that the smooth surface of the bottom surface covering 22 which contacts the feedstock coal be substantially free from dirt, dust, debris, coal residues, and other contaminates prior to use.

Once placed in the container, typically, the comminuted coal 14 is uniformly distributed on the container bottom. In some embodiments, the resulting coal bed may be compacted. Compaction results in the densification of the bed of comminuted coal. Such densification may provide for increased high density carbon foam densities. Compaction may also inhibit the formation of cracks, fissures, or other large void volumes on or within the high density carbon foam. Compaction may be accomplished by tamping, vibration, or the application of a force (i.e., a compaction force), to compact the comminuted coal particles. Typically, the compaction force is not sufficient to cause the coal bed to become a self-supporting coherent mass. However, in other embodiments, the compaction force may be sufficient to cause the coal bed to become a self-supporting coherent mass. In embodiments, where a compaction force sufficient to cause the coal bed to become a self-supporting coherent mass is utilized, the coal may be compacted prior to introduction into the container 12.

After being placed in the container 12, the top surface 18 of the coal bed may be optionally covered with a rigid sheet material 16. The rigid sheet material 16 may be a metal sheet, a metal plate, or other material that has at least one face with a smooth solid surface. The smooth solid surface is preferably placed against the top of the coal feedstock bed. Suitable rigid metal sheets, metal plates, and other materials, should be capable of tolerating the process temperatures and pressures used in production of the high density carbon foam. Additionally, the rigid sheet material 16 should be essentially non-reactive with the feedstock coal or any products thereof. Furthermore, the rigid sheet material 16 should not be significantly wetted by the plastic feedstock coal. Preferably, the rigid sheet material 16 should not significantly absorb or adsorb the plastic feedstock coal. In certain embodiments, the rigid sheet material 16 may provide for good heat transport between the atmosphere above the rigid sheet material and the feedstock coal or resultant high density carbon foam under the rigid sheet material. Suitable rigid sheet materials 16 may include metal sheets and plates, non-porous or glazed ceramic plates or sheets, and the like. Other embodiments may include graphite, or carbon, sheets that satisfy the above discussed criteria as the rigid sheet material. It is generally preferable that the smooth surface of the rigid sheet material which contacts the feedstock coal be substantially free from dirt, dust, debris, coal residues, and other contaminates prior to use. Examples of a suitable rigid sheet material 16 include, but are not limited to, 1/16″ thick aluminum plate, ⅛″ thick aluminum plate, and about 0.070″ thick 316 stainless steel sheet.

As desired, a coal bed covering 20 may be used between the top of the coal bed 18 and the bottom surface of the rigid sheet material 16. The same type of materials as used for bottom surface coverings may be used as the coal bed covering 20. For example, aluminum foil may be placed between the coal bed 14 and the rigid sheet material 16. When so placed, such materials serve very much the same type of function(s) as do bottom surface coverings. Therefore, the useable types and desired characteristics of these materials are essentially the same as for bottom surface coverings.

It is generally advisable that the compressive force exerted on the coal bed by the rigid sheet material, if utilized, be optimized. Generally, for a given set of process conditions, the density of the resultant high density carbon foam may increase as the compressive force exerted by the rigid sheet material increases. However, the compressive force should not be so large as to result in the softened coal forming a nonporous mass. If such a nonporous mass is formed, the softened coal may swell during the heating step and form low density carbon foam. Other factors limiting the compressive force maximum may include, for example, practicality, container size, and heat transfer limitations. Effective compressive forces do not have to be large. For example, forces as low as about 0.02 pounds per square inch of coal bed top surface area have been found to positively impact the formation of dense carbon foams for some coals and process conditions. For other coals and process conditions, forces of 0.2 pounds per square inch have resulted in very high quality dense carbon foams. The compressive force may be increased by increasing the mass of the rigid sheet material. Increasing the mass of the rigid sheet material often results in increases its thickness, which in turn, has the undesired consequence of lower heat transfer ability.

Rather than increasing the thickness of the rigid sheet material to increase its mass and the compressive force on the coal bed, the compressive force may also be increased by the use of one or more weights. The weight(s) may be placed on the upper surface, or connected to, the rigid sheet material to further increase the compressive force. As desired, a weight may have projections, such as legs, so that the mass of the weight contributes to the compressive force exerted on the coal by the rigid sheet material but does not significantly contact the rigid sheet material. By this and similar methods, the use of a weight may minimally impact the heat transfer between the atmosphere above the rigid sheet material and the feedstock coal or resultant high density carbon foam under the rigid sheet material.

A lid 24 of the container 12 may be placed on the container and covering the coal bed 14. It is generally advisable that the volatile material released by the coal be retained, as much as possible, in the gas volume surrounding the coal. Incorporation of a lid 24 with the container 12 promotes this retention. Without intending to be bound by theory, it is believed that such retention promotes the softening of the coal at elevated temperatures. Certain container designs not encompassing a lid preferably will have provision for retaining, at least for some period of time, the evolved volatile material in the gas volume (i.e. atmosphere) surrounding the coal.

The comminuted coal 14 and container 12 may then be heated to a first elevated temperature. Heating is preferably conducted under an atmosphere that is essentially inert, non-oxidizing, or otherwise non-reactive except for the gases or vapors evolved by the coal at elevated temperatures. Such an atmosphere may be partly or totally comprised of, for example, nitrogen, neon, argon, xenon, carbon dioxide, and the like. The pressure of this atmosphere may be any pressure ranging from that of the local environment (about 0 psig) to 500 psig or more. The magnitude of the first elevated temperature is sufficient to cause the coal particles to become softened (i.e., plastic), at least partially melt (i.e., to become at least partially fluid), and intermix together, where the individual coal particles substantially lose their individual characteristics and become substantially homogeneous with one another, thus forming a generally homogeneous, non-sintered, open cell carbon material. The degree to which the coal particles lose their individual characteristics or identity by melting and intermixing to form a continuous, open cell structure, generally increases with increasing temperature to at least the first elevated temperature. Typically, the greater the degree to which the coal particles melt and intermix together, the greater the strength of the high density carbon foam. Therefore it is usually preferred to use as high a first elevated temperature as possible within the limits of control of the process. Heating the coal to too high a temperature, this is, a temperature that is greater than the first elevated temperature, may result in the in the coal particles melting together to form a generally homogeneous, closed cell carbon material. This closed cell carbon material may develop into a low density carbon foam, or coke, with continued heating. Therefore, a first elevated temperature may be a temperature less than that at which a closed cell carbon material develops. In certain embodiments, the first elevated temperature is a temperature just less than that temperature at which a closed cell carbon material develops. For those coals that, due to process conditions or other reasons, do not exhibit the required fluidity at elevated temperatures to form a closed cell carbon material, the first elevated temperature may be a temperature which maximizes the softening of the coal. In certain embodiments, this elevated temperature will result in the maximizing of the density of the resultant high density carbon foam.

The coal bed may be heated at a relatively high (i.e. rapid) rate until some portion of the coal bed achieves a temperature sufficient for the coal to become just slightly softened. From that temperature to the first elevated temperature, heating may be performed at a rate such that significant temperature gradients are not produced in the coal mass comprising the coal bed. The development of such gradients in the coal mass comprising the coal bed are usually to be avoided as they may lead to cracking of the resultant high density carbon foam and/or the development of other non-uniform properties within the foam. During the process of heating the coal bed to the first elevated temperature, the coal mass comprising the coal bed transforms into a generally homogeneous, non-sintered, open cell carbon material.

Once the carbon material achieves the first elevated temperature, heating may be continued at that temperature, or a lower temperature, until the resultant generally homogeneous, non-sintered, open cell carbon material is no longer plastic or capable of becoming plastic. That is, heating may be continued until the generally homogeneous, non-sintered, open cell carbon material is no longer a plastic material capable of being substantially softened. Alternatively, the generally homogeneous, non-sintered, open cell carbon material may be heated to temperatures greater than the first elevated temperature if such heating is conducted at a rate such that the thermoplastic character of the generally homogeneous, non-sintered, open cell carbon material decreases with increasing temperature above the first elevated temperature. That is, the generally homogeneous, non-sintered, open cell carbon material may be heated to temperatures greater than the first elevated temperature if the carbon material of the generally homogeneous, non-sintered, open cell carbon material becomes no more softened or plastic at those elevated temperatures than the carbon material was at the first elevated temperature. Heating of the carbon material at such elevated temperatures may be for a period of time sufficient to essentially eliminate the plastic character of the generally homogeneous, non-sintered, open cell carbon material.

Once the generally homogeneous, non-sintered, open cell carbon material is essentially no longer plastic, the resulting material is now high density carbon foam. As desired, the resultant high density carbon foam may be cooled to essentially ambient temperatures or immediately or subsequently heated to a second elevated temperature as great as about 3200° C., followed by cooling. Various properties of the resulting high density carbon foam may be greatly improved by such heating to elevated temperatures, with subsequent cooling, following preparation. Such properties may include, but are not limited to, mechanical strength, including crush strength, and electrical conductivity. In some embodiments, such second elevated temperatures may be greater than about 700° C., and more typically greater than about 950° C. Both heating and cooling should be conducted at rates such that undesired cracking, or other degradation, of the foam does not occur as a result, for example, of significant thermal gradients produced within the foam. In certain embodiments, such heating or cooling may be conducted in an essentially inert, non-oxidizing, or otherwise non-reactive atmosphere.

For a given coal, the value of the first elevated temperature is affected by a number of process variables. Generally, higher process atmospheric pressures may widen the range and lower the values of the range of temperatures suitable for forming the high density carbon foams of the present invention. That is, the value of the first elevated temperature may decrease, and a wider range of temperatures may be useable as first elevated temperatures, with increasing process atmospheric pressures.

Additionally, longer heating times at elevated temperatures, even those elevated temperatures less than or equal to the first elevated temperature, may reduce the plastic properties of the coal such that the first elevated temperature is shifted to higher values of temperature. In some instances, as a result of longer heating times at elevated temperatures, a coal may not become sufficiently plastic to produce a high density carbon foam as dense as might otherwise be produced. If heating at elevated temperatures significantly less than the first elevated temperature is excessively long, a sintered product, rather than a carbon foam, may be produced. Such sintered products may exhibit low strengths as compared to high density carbon foams.

It is expected that the plastic properties of all coals may be impacted by exposure to elevated temperatures of sufficient magnitude. Therefore, in some embodiments, temperatures useable as a first elevated temperature for coals exhibiting high degrees of fluidity, when heated, may be limited to a very narrow range of temperatures. Conversely, in other embodiments, temperatures useable as a first elevated temperature for coals exhibiting low degrees of fluidity, when heated, may be selected from a wider range of temperatures.

For some bituminous coals, the first elevated temperature may be approximately the “Initial Dilatation Temperature” as determined using an Arnu/Ruhr Dilatometer (ASTM D5515 “Standard Test Method for Determination of the Swelling Properties of Bituminous Coal Using a Dilatometer”). The value of the “Initial Dilation Temperature” is specific to each coal sample being tested. As discussed above, the process conditions to which the coal is subjected in forming the high density carbon foam may impact the temperature at which the optimum first elevated temperature is evident. Slow heating to the first elevated temperature may increase the value of this temperature to values above the “Initial Dilatation Temperature”. Heating of the coal mass under high process atmospheric pressures may lower the value of the optimum first elevated temperature to values significantly less than the “Initial Dilatation Temperature”. Therefore, while values such as the “Initial Dilatation Temperature” may provide some guidance for selection or prediction of the optimum first elevated temperature, the process variables impact heavily on the on the value of the optimum first elevated temperature. As such, experimental investigations utilizing a specific feedstock coal and process condition range are recommended for establishment of the optimum first elevated temperature and other relevant process conditions.

Additionally, it is generally not desired that the coal or resultant open cell carbon material be exposed to oxygen during processing. Such exposure can negatively impact the fluidity that may be developed by the coal and may result in an inferior high density carbon foam product.

High density carbon foam produced directly from comminuted coal particles may have carbon as the main constituent. However, other non-volatile coal constituents will also be present in the high density carbon foam material. The high density carbon foam may exhibit ash content and ash constituents reflecting those of the feedstock from which the high density carbon foam was prepared. Commonly, for coal feedstocks, such ash contents may be above about 1% by weight. Generally, in some embodiments, the ash content of high density carbon foam prepared from coal may have a value ranging from about 1% to about 20% ash. In other embodiments, the ash content of high density carbon foam prepared from coal may have a value ranging from about 2% to about 20% ash. In still other embodiments, the ash content of high density carbon foam prepared from coal may have a value ranging from about 5% to about 20% ash. Further, the high density carbon foams, when heated to temperatures greater than about 700° C., and more typically greater than about 950° C., followed by cooling to essentially ambient temperatures, may have crush strengths (i.e., compressive strengths) greater than about 5,000 lbs/in², sometimes greater than about 10,000 lbs/in², and in some embodiments greater than about 20,000 lbs/in². In certain embodiments, the high density carbon foams may exhibit crush strengths ranging from about 5,000 lbs/in² to about 25,000 lbs/in². The body of these high density carbon foams may be largely isotropic.

While the invention has been described above with respect to using agglomerating coal as the feedstock, it is expected that other solid agglomerating carbon-based materials may used as the feedstock for high density carbon foam production. Solid carbonaceous material that may be comminuted, agglomerate, and become temporarily plastic when heated may be potentially utilized as a feedstock. For example, other feedstocks may include, but are not limited to, coal extracts, hydrogenated coal extracts, and mesophase materials that are solids which become at least temporarily plastic and agglomerate when heated. Coal pitch, synthetic pitches, petroleum pitch, mesophase pitch, resins, including phenolics, and the like, may be used in combination with one or more of the solid agglomerating material feedstocks discussed above to form a high density carbon foam.

The high density carbon foam may be useful as ablation shields, heat barriers, kiln furniture, rocket nozzles, impact shields, heat exchangers, thermal protection systems, and as materials in other applications requiring high compressive strengths, tolerance to high temperatures, and/or thermal conductivities within the ranges exhibited by the high density carbon foams. Further, the high density carbon foam may be used in many applications in which graphite has previously been used.

The following examples are provided for illustrative purposes for certain embodiments of the invention and are not intended to limit the invention.

### EXAMPLE 1

An agglomerating bituminous coal that would be typically classified as a Low Volatile bituminous coal, was comminuted to a particle size less than about 140 mesh (U.S. Standard Series sieves). A portion of this comminuted coal was placed in a flat bottom container to provide an essentially uniform loading of about 13 g/in² of bottom surface area. The container had been fitted with an aluminum foil bottom surface covering prior to introduction of the coal. The resulting coal bed was then compacted in the container by dropping the container a number of times from the height of a few inches. Next, the resulting compacted coal bed was covered with a sheet of aluminum foil to provide a coal bed covering. A ⅛ inch thick aluminum plate was then placed over the coal bed covering. Weights were added to the aluminum plate such that a compressive force of about 0.11 lb/in² was applied to the top of the coal bed. The container lid was then placed on the container.

Under an essentially inert, non-oxidizing, atmosphere at ambient pressure, the container was then heated from ambient temperature to about 410° C. at a rate of about 5° C./min. Next, the container was heated from about 410° C. to about 490° C. at a rate of about 0.25° C./min. The container was then held at about 490° C. for a time period of about 8 hours. Following this heating, the container was cooled to ambient temperature at a rate of no greater then about 2.5° C./min.

The resulting high density carbon foam was then heated under an essentially inert, non-oxidizing atmosphere to a temperature of greater than about 1100° C. A portion of the resultant carbon foam exhibited a density of about 1.33 g/cc and a crush strength of about 7,900 lbs/in².

### EXAMPLE 2

The same type of bituminous coal as used in example 1 was comminuted to a particle size less than about 140 mesh (U.S. Standard Series sieves). A portion of this comminuted coal was placed in a flat bottom container to provide an essentially uniform loading of about 13 g/in² of bottom surface area. The container had been fitted with an aluminum foil bottom surface covering prior to introduction of the coal. Next, the coal bed was covered with a sheet of aluminum foil to provide a coal bed covering. A ⅛ inch thick aluminum plate was then placed over the coal bed covering. Weights were added to the aluminum plate such that a compressive force of about 0.025 lb/in² was applied to the top of the coal bed. The container lid was then placed on the container.

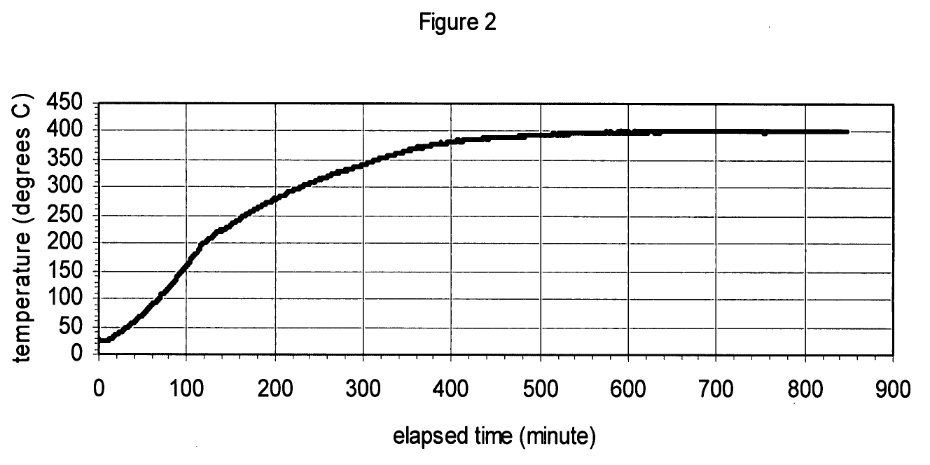

Under an essentially inert, non-oxidizing, atmosphere at a pressure between about 400 psig and about 430 psig, the container was then heated using the temperature profile shown in FIG. 2. Following this heating, the container was slowly cooled to ambient temperature. During cooling, when the container temperature was about 100° C., the pressure of the essentially inert, non-oxidizing, atmosphere was reduced to about ambient pressure.

The resulting high density carbon foam was then heated under an essentially inert, non-oxidizing, atmosphere to a temperature of greater than about 1100° C. A portion of the resultant carbon foam exhibited a density of about 1.39 g/cc and a crush strength of about 10,200 lbs/in².

### EXAMPLE 3

The same type of bituminous coal as used in example 1 was comminuted to a particle size less than about 140 mesh (U.S. Standard Series sieves). A portion of this comminuted coal was placed in a flat bottom container to provide an essentially uniform loading of about 13 g/in² of bottom surface area. The container had been fitted with an aluminum foil bottom surface covering prior to introduction of the coal. Next, the coal bed was covered with a sheet of aluminum foil to provide a coal bed covering. A ⅛ inch thick aluminum plate was then placed over the coal bed covering. Weights were added to the aluminum plate such that a compressive force of about 0.12 lb/in² was applied to the top of the coal bed. The container lid was then placed on the container.

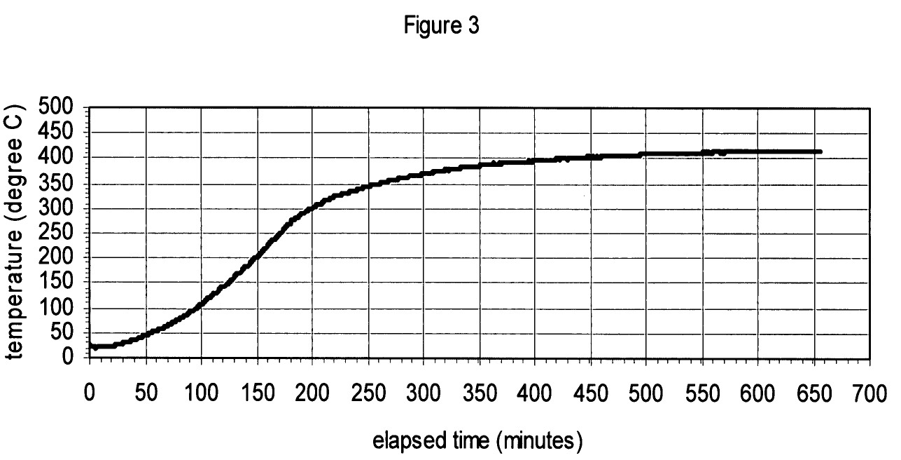

Under an essentially inert, non-oxidizing, atmosphere at a pressure between about 400 psig and about 460 psig, the container was then heated using the temperature profile shown in FIG. 3. Following this heating, the container was slowly cooled to ambient temperature. During cooling, when the container temperature was about 100° C., the pressure of the essentially inert, non-oxidizing, atmosphere was reduced to about ambient pressure.

The resulting high density carbon foam was then heated under an essentially inert, non-oxidizing, atmosphere to a temperature of about 1050° C. A portion of the resultant carbon foam exhibited a density of about 1.48 g/cc and a crush strength of greater than about 17,300 lbs/in².

While the invention has been described above in detail with respect to certain embodiments, the present invention is limited only by the following appended claims.

What is claimed is:

1. A high density carbon foam comprising a open celled body comprised of interconnected, continuous carbon ligaments, wherein the high density carbon foam has a density greater than about 0.8 g/cc and an ash content greater than about 1%.

2. The high density carbon foam of claim 1, wherein said ash content is greater than about 2%.

3. The high density carbon foam of claim 1, wherein said ash content is greater than about 5%.

4. The high density carbon foam of claim 1, wherein said ash content is greater than about 2% and less than about 20%.

5. The high density carbon foam of claim 1, wherein said density is greater than about 1.0 g/cc

6. The high density carbon foam of claim 1, wherein said density is greater than about 0.8 g/cc and less than about 2.0 g/cc.

7. The high density carbon foam of claim 1, wherein said density is greater than about 1.2 g/cc and less than about 1.8 g/cc.

8. The high density carbon foam of claim 1, wherein said density is greater than about 1.3 g/cc and less than about 1.6 g/cc.

9. The high density carbon foam of claim 1, wherein said high density carbon foam has a crush strength above about 5,000 lbs/in².

10. The high density carbon foam of claim 1, wherein said high density carbon foam has a crush strength above about 10,000 lbs/in².

11. The high density carbon foam of claim 1, wherein said high density carbon foam has a crush strength above about 20,000 lbs/in².

12. The high density carbon foam of claim 1, wherein said high density carbon foam has a crush strength ranging from about 5,000 lbs/in² to about 25,000 lbs/in².

13. The high density carbon foam of claim 1, wherein said ash content is greater than about 2% and less than about 20%, said density is greater than about 1.2 g/cc and less than about 1.8 g/cc, and said high density carbon foam has a crush strength ranging from about 5,000 lbs/in² to about 25,000 lbs/in².

14. A method for producing a high density carbon foam, comprising the steps of:
heating a comminuted, agglomerating carbonaceous feedstock to a first elevated temperature, wherein said first elevated temperature is sufficient to form a substantially homogeneous, non-sintered, open cell carbon material, and
maintaining said generally homogeneous, open cell carbon material at an elevated temperature for a period of time sufficient to essentially eliminate the plastic property of said substantially homogeneous, non-sintered, open cell carbon material to provide a high density carbon foam.

15. The method of claim 14, wherein said solid carbonaceous feedstock is selected from the group consisting of coal extracts, hydrogenated coal extracts, and mesophase materials.

16. The method of claim 14, wherein said carbonaceous feedstock is an agglomerating bituminous coal.

17. The method of claim 14, further comprising the step of heating said high density carbon foam at a second elevated temperature greater than about 700° C.

18. The method of claim 17, wherein said second elevated temperature is greater than about 950° C.

19. The method of claim 14, wherein said heating is conducted under an essentially inert, non-oxidizing atmosphere.

20. The method of claim 17, wherein said heating is conducted under an essentially inert, non-oxidizing atmosphere.

21. The method of claim 18, wherein said heating is conducted under an essentially inert, non-oxidizing atmosphere.

22. The method of claim 19, wherein said atmosphere has a pressure between about 0 psig and about 500 psig.

23. The method of claim 19, further comprising the step of cooling said high density carbon foam to essentially ambient temperature under an essentially inert, non-oxidizing atmosphere.

24. The method of claim 17, further comprising the step of cooling said high density carbon foam to essentially ambient temperature under an essentially inert, non-oxidizing atmosphere.

25. The method of claim 18, further comprising the step of cooling said high density carbon foam to essentially ambient temperature under an essentially inert, non-oxidizing atmosphere.

26. A method for producing a high density carbon foam, the method comprising the steps of:
loading a container with comminuted coal to form a coal bed, wherein the comminuted coal is an agglomerating bituminous coal;
applying a compressive force on the coal bed;
covering the container with a lid;
heating the coal bed to a first elevated temperature, wherein the first elevated temperature is sufficient to form a substantially homogeneous, non-sintered, open cell carbon material; and
continued heating of the substantially homogeneous, non-sintered, open cell carbon material at an elevated temperature for a time sufficient to essentially eliminate the plastic property of the substantially homogeneous, non-sintered, open cell carbon material to provide a high density carbon foam.

27. The method of claim 26, further comprising the step of heating said high density carbon foam to a second elevated temperature greater than about 700° C.

28. The method of claim 27, wherein said second elevated temperature is greater than about 950° C.

29. The method of claim 26, wherein said heating is conducted under an essentially inert, non-oxidizing atmosphere.

30. The method of claim 27, wherein said heating is conducted under an essentially inert, non-oxidizing atmosphere.

31. The method of claim 28, wherein said heating is conducted under an essentially inert, non-oxidizing atmosphere.

32. The method of claim 26, further comprising the step of cooling said high density carbon foam to essentially ambient temperature under an essentially inert, non-oxidizing atmosphere.

33. The method of claim 27, further comprising the step of cooling said high density carbon foam from said to essentially ambient temperature under an essentially inert, non-oxidizing atmosphere.
